(19) United States
(12) Patent Application Publication
(10) Pub. No.: US 2007/0045554 A1
(43) Pub. Date: Mar. 1, 2007

(54) Radiation detector

(75) Inventors: Shunsuke Wakamatsu, Otawara-shi (JP); Shinetsu Fujieda, Kawasaki-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 11/509,671

(22) Filed: Aug. 25, 2006

(30) Foreign Application Priority Data
Aug. 26, 2005 (JP) 2005-246007

(51) Int. Cl. G01T 1/20; G01T 1/24

(52) U.S. Cl. 250/370.11

(57) ABSTRACT

A radiation detector comprises an electrode substrate, pixel electrodes provided on the electrode substrate, and detecting electric signals, a radiation conversion layer provided on the pixel electrodes, and converting incident radiations into electric signals, upper electrodes provided at a position on the radiation conversion layer opposite to the pixel electrodes, and a protective layer provided on the upper electrode, the protective layer having a flexural modulus not more than a flexural modulus of the electrode substrate.

### CROSS-REFERENCE TO RELATED APPLICATIONS

This application is based upon and claims the benefit of priority from prior Japanese Patent Application No. 2005-246007, filed Aug. 26, 2005, the entire contents of which are incorporated herein by reference.

### BACKGROUND OF THE INVENTION

1. Field of the Invention

The present invention relates to a radiation detector for converting incident radiations into electric signals.

2. Description of the Related Art

An active matrix type planar detector has been developed as an X-ray diagnostic image detector of new-generation. The planar detector detects irradiated X-rays, whereby an X-ray photographed image or an X-ray image in real time is output as a digital signal.

Then, there are two methods of a direct method and an indirect method as being classified largely in this kind of the planar detector. The direct method is a method for acquiring an image in such a manner as to convert the X-ray into a charge signal directly with an X-ray conversion film. On the other hand, the indirect method is a method for acquiring an image in such a manner that, after the X-ray is converted into visible light with a scintillator layer, the visible light is converted into charge signals by photoelectric conversion elements such as an amorphous silicon (a-Si) photodiode or CCD.

Then, the X-ray conversion film for use in the planar detector of the direct method uses amorphous selenium (a-Se), lead iodide (PbI₂), mercuric iodide (HgI₂) or the like as materials, or use thereof is investigated. Further, since the X-ray conversion film converts directly the X-ray into the charge signal with the X-ray conversion film, it is possible to acquire the image in excellent resolution characteristic. However, since the X-ray conversion film causes material deterioration when allowing it to stand in an air atmosphere, sensitivity characteristics or resolution characteristics deteriorate.

In addition, the scintillator layer for use in the planar detector of the indirect method uses cesium iodide: sodium (CsI:Na), cesium iodide: thallium (CsI:Tl), sodium iodide (NaI), gadolinium oxide sulfide (Gd₂O₂S) or the like as the materials. Further, the scintillator layer can improve the resolution characteristics by providing a columnar structure in such a manner as to form to deposit the columnar structure or by forming a trench due to dicing or the like. On the contrary, many of the materials used for the scintillator layer have high hygroscopicity, and therefore, when allowing it to stand in an air atmosphere, the sensitivity characteristics or the resolution characteristics deteriorate.

Accordingly, in order to prevent deterioration of the characteristics of the X-ray conversion film for use in the planar detector of the direct method or the scintillator layer for use in the planar detector of the indirect method, it is necessary to provide a protective layer having shielding performance to the atmosphere and the moisture as well as having permeability to the X-ray. As the protective layer, the following configurations have been known. That is, for example, Jpn. Pat. Appln. KOKOKU Publication No. 05-39558 (Pages 2 to 3, and FIGS. 1 and 3) discloses a configuration in which an organic film of a xylene-based resin is formed by an evaporation deposition method in a vacuum or in an inert gas atmosphere. Jpn. Pat. Appln. KOKOKU Publication No. 06-58440 (Pages 2 to 5, and FIG. 1) discloses a configuration in which an inorganic film of silicon oxynitride or the like is formed.

However, the protective film obtained by the evaporation deposition method described above has a small film thickness, and has defects such as pinhole, so that moisture permeability is large. Further, coating along the substrate end side of the protective layer is insufficient for long time suppression of deterioration of the sensitivity characteristics or the resolution characteristics because the moisture permeability of interface between the substrate and the resin becomes large. Furthermore, the defect such as the pinhole causes micro discharge in the direct method, which leads to deterioration of the protective film itself.

The protective layer composed of the organic film described above has little defects such as the pinhole immediately after formation, and is hard to generate cracks even with a thin film. However in a heating process at assembly of the X-ray detector, its temperature exceeds a glass transition temperature (Tg), and thus, there is a fear that defects such as the pinhole occur due to softening and modification. Moreover, in the protective layer composed of the inorganic film described above, there is no defect occurrence due to the heating process because the glass transition temperature (Tg) is high. However, since mechanical strength at a thin film is small, cracks are easy to be generated, and realization of a thick film is not easy.

Then, the formation by means of the evaporation deposition method has problems that it is not easy to obtain the high sensitivity characteristics and the high resolution characteristics with long time stability. This is because the protective film is deposited in a gap of columnar crystal in the indirect method, and reflection efficiency within the columnar crystal becomes small since a refractive index ratio between the columnar crystal and the gap becomes approximately 1, so that the resolution and luminous efficiency deteriorate.

### BRIEF SUMMARY OF THE INVENTION

The present invention has been achieved in consideration of the above circumstances, and it is an object of the present invention to provide a radiation detector having high sensitivity characteristics and resolution characteristics with long term stability.

In order to achieve the above object, according to an aspect of the present invention, there is provided a radiation detector comprising:

an electrode substrate;

pixel electrodes provided on the electrode substrate, and detecting electric signals;

a radiation conversion layer provided on the pixel electrodes, and converting incident radiations into electric signals;

upper electrodes provided at a position on the radiation conversion layer opposite to the pixel electrodes; and

a protective layer provided on the upper electrodes, the protective layer having a flexural modulus not more than a flexural modulus of the electrode substrate.

According to another aspect of the present invention, there is provided a radiation detector comprising:

an electrode substrate;

photoelectric conversion elements provided on the electrode substrate, and converting visible light into electric signals;

a scintillator layer provided on the photoelectric conversion elements, and converting incident radiations into the visible light; and

a protective layer provided on the scintillator layer, and having a flexural modulus not more than a flexural modulus of the electrode substrate.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory perspective view showing a radiation detector according to a first embodiment of the present invention in a state that part thereof is cut;

FIG. 2 is an explanatory cross sectional view of the radiation detector of FIG. 1; and

FIG. 3 is an explanatory cross sectional view showing a radiation detector according to a second embodiment of the present invention.

### DETAILED DESCRIPTION OF THE INVENTION

Hereinafter, there will be described a radiation detector according to first embodiment of the invention in detail with reference to the accompanied drawings.

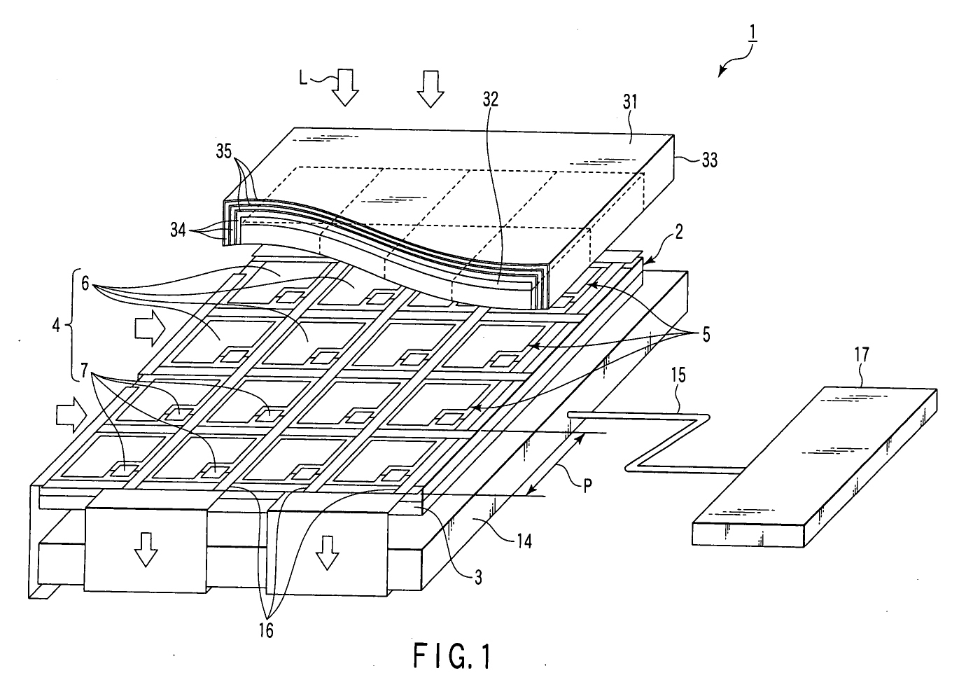

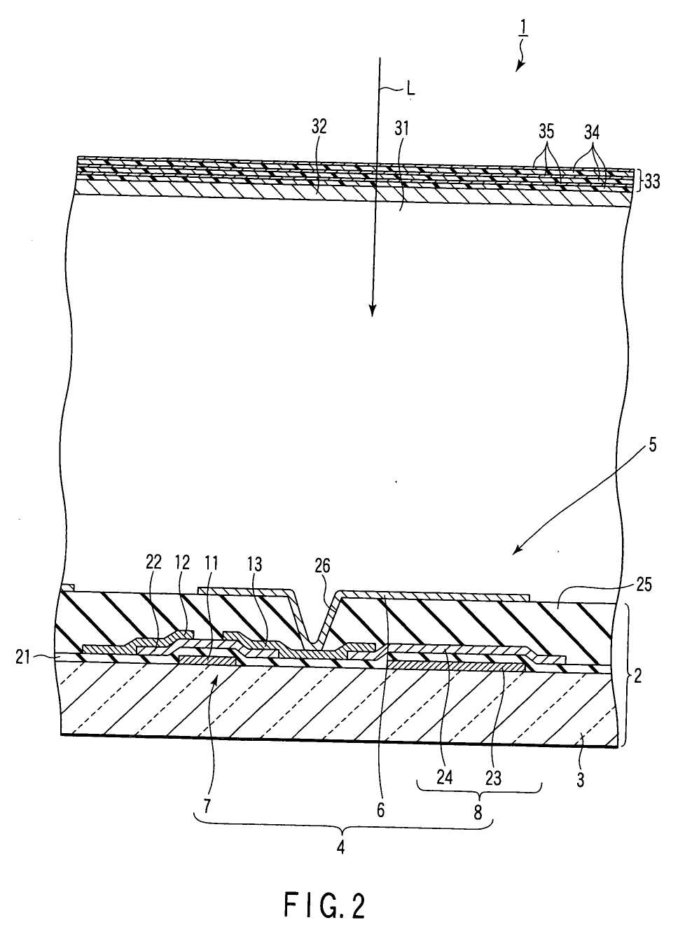

As shown in FIGS. 1 and 2, an X-ray detector 1 is a radiation detector of a direct method. The X-ray detector 1 is a direct conversion type X-ray planar sensor which serves as an X-ray planar detector for detecting an X-ray image. Further, the X-ray detector 1 is provided with a photoelectric conversion substrate 2 as a TFT circuit, and the photoelectric conversion substrate 2 is an active matrix optical conversion substrate as a TFT circuit substrate.

Then, the photoelectric conversion substrate 2 has a glass substrate 3 as an electrode substrate using an insulating material with translucent, such as a glass. The glass substrate 3 is composed of Corning 1737 (trade name: manufactured by CORNING COMPANY) in which a flexural modulus at room temperature (25° C.) is approximately 6 GPa, for example. Further, on the surface as being one principal surface of the glass substrate 3, a plurality of substantially rectangular shaped photoelectric conversion units 4 as an X-ray photoelectric conversion unit which functions as a photo sensor are arranged and formed into a matrix shape. Then, on the surface of the glass substrate 3, pixels 5 serving as plural detection element array units each having the same structure are provided by the photoelectric conversion units 4. The pixels 5 are thin film element pixels formed in such a manner that the pixels 5 are arranged two dimensionally with a predetermined pitch P in respective row directions being lateral directions in FIG. 1 and in respective column directions being vertical directions in FIG. 1.

Then, each of a substantially L-shaped tabular pixel electrode 6 serving as a current collection electrode for detecting and collecting an electric signal or a signal charge is provided the pixel 5. The pixel electrodes 6 are provided in pixel unit, that is, provided at a center part of each pixel 5 on the surface of the glass substrate 3. Here, these pixel electrodes 6 are formed of an indium-tin oxide (ITO) transparent conductive film or aluminum (Al) thin film by, for example, a sputtering method or an electron beam (EB) deposition method.

Further, a thin film transistor (TFT) 7 as a switching element constituting a switching unit is electrically connected to each of the pixel electrodes 6. The thin film transistors 7 are composed of amorphous silicon (a-Si) serving as an amorphous semiconductor which is a semiconductor material having crystallinity. Further, the thin film transistors 7 accumulate or emit charges based on a potential difference detected by the pixel electrodes 6. Each thin film transistors 7 is provided on the respective pixel 5. Furthermore, the thin film transistors 7 each have a gate electrode 11, a source electrode 12 and a drain electrode 13.

Further, a rectangular tabular accumulating capacitor 8 is provided at each pixel 5. The accumulating capacitor is an accumulating element as a charge storage capacitor unit for accumulating a signal charge detected by the pixel electrode 6. Each of the accumulating capacitors 8 is provided under the corresponding pixel electrode 6 while facing to the pixel electrode 6. Then, the drain electrodes 13 of the respective thin film transistors 7 are connected to the pixel electrodes 6 and the accumulating capacitors 8.

Further, a high speed signal processing unit 14 is mounted at one side edge on the surface of the glass substrate 3 along a row direction. The high speed signal processing unit 14 is a control circuit as an elongated driver circuit of a rectangular tabular shape which controls an operation state of each thin film transistor 7, for example, which controls ON and OFF of each thin film transistor 7. The high speed signal processing unit 14 is a line driver as a signal processing circuit for controlling reading out of signals, or processing read-out signals. The high speed signal processing unit 14 has a major axis along a column direction on the surface of the glass substrate 3, and is arranged in a state of being bent at a rear surface side of the glass substrate 3. That is, the high speed signal processing unit 14 is mounted on the rear surface side of the glass substrate 3 while facing to the glass substrate 3.

One end of each of a plurality of control lines 15 is electrically connected to the high speed signal processing unit 14. The control lines 15 are wired along the row direction of the glass substrate 3, and are provided between the respective pixels 5 on the glass substrate 3. Further, the control lines 15 are electrically connected to the respective gate electrodes 11 of the thin film transistors 7 constituting the pixels 5 of the same row.

Further, on the surface of the glass substrate 3, a plurality of data lines 16 are wired along a column direction of the glass substrate 3. These data lines 16 are provided between the respective pixels 5 on the glass substrate 3. The data lines 16 are electrically connected to the source electrodes 12 of the thin film transistors 7 constituting the pixels 5 of the same column. That is, the data lines 16 receive image data signals from the thin film transistors 7 constituting the pixels of the same column.

Then, one end of each of the data lines 16 is electrically connected to the high speed signal processing unit 14. Further, a digital image transmitting unit 17 serving as a digital image processing unit is electrically connected to the high speed signal processing unit 14. The digital image transmitting unit 17 is mounted in a state of being led out at outside the photoelectric conversion substrate.

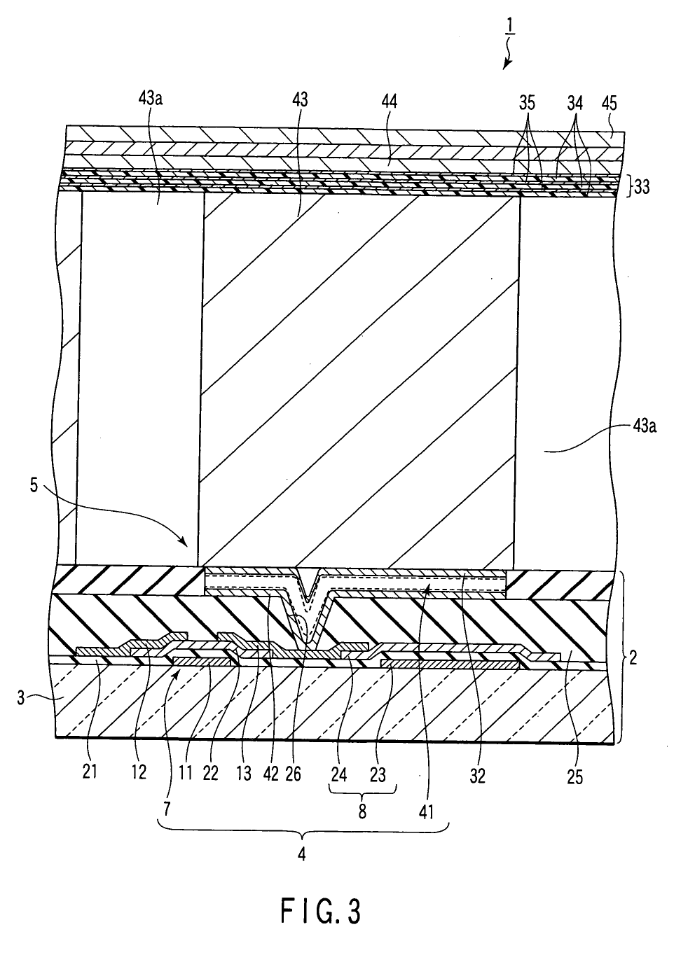

On the other hand, as shown in FIG. 3, respective thin film transistor 7 and accumulating capacitor 8 are formed on each pixel 5 on the surface of the glass substrate 3. Here, the thin film transistors 7 each are provided with an island shaped gate electrode 11 formed on the glass substrate 3. Then, an insulating film 21 is laminated and formed on the glass substrate 3 and the gate electrodes 11. The insulating film 21 covers the gate electrodes 11.

In addition, a plurality of island shaped semi-insulating films 22 are laminated and formed on the insulating film 21. The semi-insulating films 22 cover the respective gate electrodes 11 while being arranged opposite to the gate electrodes 11. More specifically, the semi-insulating films 22 are provided on the gate electrodes 11 via the insulating film 21. Further, on the insulating film 21 and the semi-insulating films 22, source electrodes 12 and drain electrodes 13 are formed. Each source electrode 12 and each drain electrode 13 are insulated from each other and are not electrically connected with each other. Each source electrode 12 and each drain electrode 13 are provided at both sides on the gate electrode 11, and respective one end parts of the source electrode 12 and drain electrode 13 are laminated on the semi-insulating film 22.

Then, the gate electrode 11 of each thin film transistor 7 is electrically connected to a common control line 15 together with the gate electrodes 11 of the other thin film transistors 7 positioned at the same row. Further, the source electrode 12 of each thin film transistor 7 is electrically connected to a common data line 16 together with the source electrodes 12 of the other thin film transistors 7 positioned at the same column.

On the other hand, the accumulating capacitor 8 is provided with an island shaped lower electrode 23 formed on the glass substrate 3. On the glass substrate 3 and the lower electrodes 23, the insulating film 21 is laminated and formed. The insulating film 21 extends over until the respective lower electrodes 23 from the gate electrodes 11 of the thin film transistors 7. Further, an island shaped upper electrodes 24 are formed on the insulating film 21. Each upper electrode 24 is arranged opposite to the lower electrode 23 to cover the lower electrode 23. More specifically, the upper electrodes 24 are provided on the lower electrodes 23 via the insulating film 21. Then, the drain electrodes 13 are formed on the insulating film 21 and the upper electrode 24. Each drain electrode 13 other end part of which is laminated on the upper electrode 24, is electrically connected to the upper electrode 24.

Further, a flattening layer 25 as the insulating layer is laminated and formed on the insulating film 21, the semi-insulating films 22, the source electrodes 12, the drain electrodes 13 and the upper electrodes 24. The flattening layer 25 is made of resin, and through holes 26 are opened to be formed at parts of the flattening layer 25. Each through hole 26 is a contact hole serving as a communicating part communicated with the drain electrode 13 of the thin film transistor 7. The pixel electrodes 6 are formed on the flattening layer 25 and the through holes 26. Accordingly, each pixel electrode 6 is electrically connected to the drain electrode 13 of the thin film transistor 7 via the through hole 26.

Further, a photo conductive layer 31 serving as a radiation conversion layer for converting an X-ray as incident radiation into a charge is formed to be laminated on the flattening layer 25 and the pixel electrodes 6. The photoconductive layer 31 is an X-ray photoconductive film as an X-ray conversion film for converting an incident X-ray into an electric signal. Here, the pixel electrodes 6 are provided below the photoconductive layer 31 which is a side opposite to the X-ray made incident to the photoconductive layer 31 in a state of coming into contact with the photoconductive layer 31 directly. In other words, the pixel electrodes 6 are provided at a position opposite to the photoconductive layer 31 which is incident direction side to which the X-ray L is made incident. That is, the pixel electrodes 6 are provided at underside of the photoconductive layer 31 positioned opposite to the side to which the X-ray L is made incident with respect to the photoconductive layer 31.

Then, the photoconductive layer 31 is composed of an X-ray photoconductive material which is a photoconductive material for converting an incident X-ray L into an electric signal. Here, the X-ray photoconductive material of the photoconductive layer 31 contains at least one kind of lead iodide (PbI₂), mercuric iodide (HgI₂), indium iodide (InI), thallium iodide (TlI) and bismuth iodide (BiI₃) as heavy metal halide. More specifically, the X-ray photoconductive material contains Iodine (I) as halogen.

Further, a bias electrode layer 32 which is a thin film electrode as an upper electrode is laminated and formed on the photoconductive layer 31. The bias electrode layer 32 is a bias electrode film laminated uniformly over the whole photoelectric conversion unit 4. Also, the bias electrode layer 32 is provided at a position opposite to the pixel electrodes 6. In other words, the bias electrode layer 32 is provided on the surface of the photoconductive layer 31 opposite to the side where the glass substrate 3 is positioned.

Then, the bias electrode layer 32 is formed of an indium-tin oxide (ITO) transparent conductive film or aluminum (Al) thin film formed by, for example, a sputtering method or an electron beam (EB) deposition method. Accordingly, the bias electrode layer 32 is formed integrally such that a bias electric field can be formed between the bias electrode 32 and the pixel electrodes 6 by applying a common bias voltage to the pixel electrodes 6 of the pixels 5.

Moreover, a protective film 33 as a protective layer having shielding performance to the atmosphere and the moisture, and permeability to the X-ray is laminated and formed on the bias electrode layer 32. The protective film 33 covers respective upside of the bias electrode layer 32 of the photoelectric conversion unit 4 and periphery of the bias electrode layer 32. Then, the protective film 33 is composed of an epoxy resin layer 34 having a flexural modulus not more than the flexural modulus of the glass substrate 3. The epoxy resin layer 34 is composed of an epoxy resin whose flexural modulus at the room temperature (25° C.) is not more than 5 GPa, preferably not more than 1 GPa.

Then, the epoxy resin layer 34 is a multilayered protective film constituted in such a manner that at least two moisture barrier layers 35 as moisture-proof layers are laminated. Consequently, the protective film 33 is constituted in such a manner that at least two moisture barrier layers 35 are laminated on the epoxy resin layer 34 to form a multilayered lamination, and moisture permeability is set to less than 50 g/m²·day. At this time, the protective film 33 is constituted such that the epoxy resin layer 34 is positioned on the bias electrode layer 32, and that the moisture barrier layer 35 is positioned at the outermost of the protective film 33. In other words, in the protective film 33, an inner layer coming into contact with the bias electrode layer 32 is the epoxy resin layer 34, and the outermost layer is the moisture barrier layer 35.

In this case, examples of raw materials becoming a main substance of the epoxy resin in the epoxy resin layer 34 of the protective film 33 may include bisphenol A type epoxy resin, bisphenol F type epoxy resin, biphenyl type epoxy resin, phenol novolac type epoxy resin, orthocresol novolac type epoxy resin, dicyclopentadiene novolac type epoxy resin, tris-hydroxyphenyl methane type epoxy resin, and other polyfunctional epoxy resins.

Other examples of raw materials becoming a main substance of the epoxy resin may include alicyclic epoxy resin; heterocyclic epoxy resin such as, triglycidyl isocyanate or hydantoin epoxy; hydrogenated bisphenol A type epoxy resin; aliphatic epoxy resin such as propylene glycol diglycidyl ether or pentaerythritol polyglycidyl ether; epoxy resins obtained by reaction between aliphatic or aromatic carboxylic acid and epichlorohydrin; spiro ring containing epoxy resin; glycidyl ether type epoxy resin which is a reactive product between an ortho-allylphenol novolac compound and epichlorohydrin; and glycidyl ether type epoxy resin which is a reactive product between a diallyl bisphenol compound having an allyl group in the ortho-position of the hydroxyl group of bisohenol A, and epichlorohydrin.

Further, examples of raw materials becoming a main substance of the epoxy resin may include olygomer type denatured bisphenol A type epoxy resin into which a low-polar bonding group is introduced for the purpose of giving plasticity, and also may include brominated epoxy resin in order to give flame retardance. Here, from a viewpoint of preparing a resin composition to be a lowly viscous and easy-handling, it is preferable to use, as the epoxy resin, liquid epoxy resin having a viscosity at a room temperature (25° C.) of not more than 500 poises, and more preferably, not more than 300 poises.

Then, examples of the liquid epoxy resin may include Epikote 825, Epikote 827, Epikote 828, Epikote 828EL, Epikote 828XA, Epikote 834, Epikote 801, Epikote 801P, Epikote 802, Epikote 802XA, Epikote 815, Epikote 815XA, Epikote 816A, Epikote 819, Epikote 806, Epikote 806L and Epikote 807 (trade name: manufactured by Japan Epoxy Resins Co., Ltd.).

Other examples of the liquid epoxy resin may include EP-4100, EP-4100G, EP-4100E, EP-4100W, EP-4100TX, EP-4300E, EP-4340, EP-4200, EP-4400, EP-4500A, EP-4510, EP-4520, EP-4520S, EP-4520TX, EP-4530, EP-4901, EP-4901E, EP-4950, EP-4000, EP-4005, EP-1307, EP-4004, EP-4080E, EP-4012M, EP-4000S, EP-4000SS, EP-4003S, EP-4010S, EP-4088S, and EP-4085S (trade names: Manufactured by Asahi Denka Kogyo K.K.).

Furthermore, examples of the liquid epoxy resin may include EXA-4850-150 and EXA-4850-1000 (trade names: manufactured by Dainippon Ink and Chemicals, Incorporated); and CEL-2021P (3,4-epoxicyclohexylmethyl 3′,4′-epoxy cyclohexane carboxylate, epoxy equivalent 128 to 140, viscosity 200 to 350 cP/25° C.), CEL-2021A (3,4-epoxicyclohexylmethyl 3′,4′-epoxy cyclohexane carboxylate, epoxy equivalent 130 to 145, viscosity 200 to 450 cP/25° C.), CEL-2000 (1-vinyl-3,4-epoxycyclohexane, viscosity 1.5 cP/25° C.), CEL-3000 (1,2,8,9-diepoxylimonene, epoxy equivalent 93.5 or less, viscosity 5 to 20 cP/25° C.) (trade names: manufactured by Daicel Chemical Industries, Ltd.).

Examples of the liquid epoxy resin may also include Denacol EX-421, 201 (resorcin diglycidyl ether), 211 (neopentyl glycol diglycidyl ether), 911 (propylene glycol diglycidyl ether), and 701 (adipinic acid glycidyl ester) (trade names: manufactured by Nagase Kasei Kogyo K.K.).

Then, these epoxy resins can be used by mixture in terms of viscosity, heat resistance, adhesiveness and surface hardness. Further, as another epoxy resin, it is also possible to use one which is widely utilized as (meth)acrylate having an epoxy group.

Here, examples of the (meth)acrylate having an epoxy group may include a simple substance of glycidyl methacrylate, 2-methyl-glycidyl methacrylate, epoxidation isoprenyl methacrylate, 3,4-epoxycyclohexane methanol (metha)acrylate, and (metha)acrylic ester of ε-caprolacton denatured matter of 3,4-epoxycyclohexane methanol (metha)acrylate, such as Cycloma M100 (epoxy equivalent 196 to 213), Cycloma A200 (epoxy equivalent 182 to 195) and Cycloma M101 (epoxy equivalent 326 to 355) (trade names: manufactured by Daicel Chemical Industries, Ltd.), or which can be also used while copolymerizing another polymerizable monomer copolymerizable.

Further, examples of the polymerizable monomer for use in the copolymerization may include unsaturated fatty acid ester such as alkyl (meth)acrylate ester, hydroxyl group-containing alkyl (meth) acrylate ester, alicyclic (meth)acrylic ester, acrylic acid aromatic ester, and an alicyclic (meth)acrylic ester having a tertiary carbon atom in the ring and having 7 to 20 carbon atoms; an aromatic vinyl compound such as styrene, α-methyl styrene, α-ethyl styrene, chlorostyrene, vinyltoluene, and t-butylstyrene; a vinyl cyanide compound such as acrylonitrile, and methacrylonitrile; and N-site substituted maleimide such as N-alkyl group-substituted maleimide, N-cycloalkyl-substituted maleimide, and N-phenylmaleimide.

At this time, in the case where (meth) acrylate having an epoxy group or the like is polymerized independently or with another polymerizable monomer being copolymerizable, an initiator can be used. Examples of the initiator may include potassium persulfate, ammonium persulfate, benzoyl peroxide, hydrogen peroxide, di-t-butyl peroxide, dicumyl peroxide, 2,4-dichlorobenzoyl peroxide, dicanoyl peroxide, lauryl peroxide, cumen hydroperoxide, t-butyl hydroperoxide, acetyl peroxide, methyl ethyl ketone peroxide, succinic acid peroxide, dicetyl peroxy dicarbonate, t-butyl peroxy acetate, AIBN (2,2′-azobisisobuthylonitrile), ABN-E (2,2′-azobis(2-methylbutylonitrile)), ABN-V (2,2′-azobis(2,4-dimethylvaleronitrile)), and perbutyl O (t-butyl peroxy 2-ethylhexanoate).

Then, examples of the method of curing the above-described epoxy resin may include use of an epoxy resin system using a phenol-based curing agent an amine-based curing agent as well as homopolymerization of the epoxy resin using a cationic polymerization catalyst of the epoxy resin.

Further, the epoxy resin may select a hardening catalyst and a hardening agent appropriately from a viewpoint of suppressing a modulus of elasticity of the hardened product low. Furthermore, the epoxy resin contains an inorganic filler. That is, the inorganic filler is added in order to lower a coefficient of thermal expansion of the epoxy resin and to improve coating film formability. Specific examples of the inorganic filler include fused silica, crystalline silica, glass, talc, alumina, calcium silicate, calcium carbonate, barium sulfate, magnesia, silicon nitride, boron nitride, aluminum nitride, magnesium oxide, beryllium oxide, and mica. In this case, particularly, the fused silica or the crystalline silica is preferable as the inorganic filler. Further, examples of shapes of the inorganic filler may include granular type, spherical type, sub spherical type, fiber type, and scaled type, and particularly, the spherical or sub spherical filler with an average particle diameter of 10 μm or less is preferable. Furthermore, as the shape of the inorganic filler, a fiber type filler can be also used while aiming for the effect of reinforcing of crack resistance.

Here, examples of the fiber type filler may include whiskers such as titania, aluminum borate, silicon carbide, silicon nitride, potassium titanate, basic magnesium, zinc oxide, graphite, magnesia, calcium sulfate, magnesium borate, titanium diboride, α-alumina, chrysotile, and wallastonite; noncrystalline fibers such as E glass fiber, silica alumina fiber, and silica glass fiber; and crystalline fibers such as Tyranno fiber, silicon carbide fiber, zirconia fibers, γ-alumina fiber, α-alumina fiber, PAN-based short carbon fibers, and pitch-based carbon fiber. In this case, the fiber shaped filler is preferably has an average fiber diameter of 5 μm or less and the maximum fiber length of 10 μm or less from the viewpoint of the uniformity of the coating film surface.

Further, the inorganic filler can be used within the range of 0.1 wt. % or more and 50 wt. % or less with respect to the total amount of the resin composition. That is, in the case where the amount of the inorganic filler used is less than 0.1 wt. %, the thermal expansion of the cured products becomes large, so that thermal shock resistance becomes insufficient. In the case where the amount of the inorganic filler used is more than 50 wt. %, the fluidity of the resin composition becomes insufficient, and work efficiency deteriorates, which causes voids. Consequently, it is becomes difficult to form a uniform protective film.

It is possible to add to the resin composition thermoplastic resin, rubber component, and various kind of oligomers for the purpose of reducing the modulus of elasticity of the epoxy resin from the viewpoint of improving crack resistance at the time of a cold cycle. Here, example of the thermoplastic resin may include butyral resin, polyamide resin, aromatic polyester resin, phenoxy resin, MBS resin, and ABS resin, and it is possible to modify them with silicon oil, silicon resin, silicon rubber, fluororubber, or the like.

Further, it is possible to add various kinds of plastic powders, various kinds of engineering plastic powders or the like to the resin composition. In order to further improve adhesiveness, it is also possible to add to combine an adhesion imparting agent or a water repellent, an oil repellent, a moss repellent, an ultraviolet absorber, an antibacterial agent, an antistatic agent, a coating anchoring agent, an anticrease agent, an antioxidant, a surfactant, a coupling agent, a coloring agent or the like to the resin composition.

The resin composition can be used after mixing a filler constituent and a resin constituent uniformly by use of a three-roll, a ball mill, an automated mortar, a homogenizer, a rotation and revolution type mixing apparatus, a universal mixer, an extruder, a Henschel mixer, or the like. Further, the resin composition can be selected depending on the shape of the base materials to be coated with a screen printing method, a metal screen printing method, a dispense method, a press bonding process, a dipping, a brush coating, a roller coating, a flow coating, various kinds of spray coating, a die coater, a knife coater, a spin coater, a curtain flow coater, a reverse coater, or the like.

Further, a coating film drying method may use a natural drying, a blowing drying, a heating drying, a vacuum drying, a drying using microwave, and a drying utilizing ultrasonic wave, and temperature suitable for polymerization of the above-described epoxy resin is 18° C. or more and 150° C. or less, and more preferably, 25° C. or more and 130° C. or less. That is, when the polymerization temperature is higher than the range, the polymerization becomes unstable, so that a non-uniform compound with a higher molecular weight is created largely. To the contrary, when the polymerization temperature is lower than the range, it takes reaction time excessively, and therefore it is not preferable.

On the other hand, as the moisture barrier layer 35 to be a multilayered film formed in such a manner that the epoxy resin layer 34 of the protective film 33 is formed into the multilayered film, it is possible to use V, P2, H, T, TZ, NY, NR, and S of techbarrier film type (trade name: manufactured by Mithubishi Plastics, Inc.), and also alumina-vapor-deposited GL films GL-AU, GL-AE, GL-AEH, GL-AEY and GL-AEO, silica-vapor deposited GL film GL-E, and barrier property improved alumina-vapor-deposited GX films GX, GL-AU, and GL-AE (trade name: manufactured by Toppan Printing Co., Ltd.).

Further, as for a moisture proof film which is a moisture barrier film used as the moisture barrier layer 35, silica (SiO₂) as a silicon dioxide and a vapor-deposited film of alumina (Al₂O₃) as an aluminum oxide are taken to as a moisture shielding layer. Further, in order to improve moisture proof performance, it is also possible to use a multilayered moisture barrier film which is a moisture shielding layer of the type in which two or more of these moisture proof films are formed into a multilayered shape.

Then, a method of manufacturing the multilayered moisture barrier film and the epoxy resin includes two method, i.e., one method in which a moisture barrier film base material is converted into a stage B resin by applying the epoxy resin to the moisture barrier film base material, and the other method in which, after applying the epoxy resin on a predetermined area, the moisture barrier film is compression-bonded to integrate therewith. The multilayered moisture barrier film may be manufactured as follows. That is, the epoxy resin is made the multilayered moisture barrier film upon forming a multilayered film by applying the epoxy resin to the moisture barrier film by means of, for example, a bar coater method, a screen printing method or a dispense method. Then, the multilayered moisture barrier film is cut into a predetermined size after selecting appropriately depending on the thickness of the coating film.

Next, there will be described a function of the radiation detector of the above first embodiment.

First, an X-ray L is made incident into the photo conductive layer 31, the incident X-ray L is converted into a signal charge being an electric signal by the photo conductive layer 31. At this time, the signal charge is transported to move to the pixel electrode 6 due to a bias electric field formed between the bias electrode layer 32 and each pixel electrode 6, and is accumulated in each accumulating capacitor 8 via each drain electrode 13 from each pixel electrode 6.

On the other hand, reading of the signal charge accumulated in each accumulating capacitor 8 is sequentially controlled, for example, every row (lateral direction in FIG. 1) of the pixel unit 12 by the high speed signal processing unit 14.

At this time, the thin film transistors 7 of the pixel unit of the first line are made to be an ON state by adding, for example, an ON signal of 10 V to the gate electrodes 11 of the pixel unit positioned at the first line through the data line 16 from the high speed signal processing unit 14.

In this case, the signal charge accumulated in each accumulating capacitor 8 of the pixel unit of the first line is output as the electric signal from the drain electrode 13 to the source electrode 12. Then, the electric signal output to each source electrode 12 is amplified by the high speed signal processing unit 14.

Further, the amplified electric signal is added to the digital image transmission unit 17. The amplified electric signal is converted into a series signal, the series signal is then converted into a digital signal to be transmitted to a signal processing circuit (not shown) of the next stage.

When reading of the charge of the accumulating capacitors 8 of the pixel unit positioned at the first line is terminated, an OFF signal of −5 V is added to the gate electrodes 11 of the pixel unit of the first line through the data line 16 from the high speed signal processing unit 14, so that the thin film transistors 7 of the pixel unit of the first line are made to be an OFF state.

Thereafter, the above-described operation is performed sequentially to the pixel unit of the second and succeeding lines. Consequently, the signal charges accumulated in the accumulating capacitors 8 of the is whole pixel units are read out, and the signal charges are converted into digital signals sequentially to be output, so that the electric signal corresponding to one X-ray image is output from the digital image transmission unit 17.

As described above, according to the first embodiment, it is preferable that the flexural modulus of the epoxy resin constituting these epoxy resin layers 34 is made small as much as possible from the viewpoint of reducing the internal stress which is generated within the epoxy resin layers 34 in the protective film 33 provided on the bias electrode layer 32 of the X-ray detector 1. However, as for the protective film 33, it is conceivable that the flexural modulus is necessary by which the shape can be maintained and no mechanical damage from the external part is suffered. Accordingly, in the case of the protective film 33 whose flexural modulus at a normal temperature is nearby 5 GPa, it has been confirmed that the glass substrate 3 is broken whose flexural modulus at the normal temperature is approximate 6 GPa as a result of the experiment. For this reason, the flexural modulus at the normal temperature, of the epoxy resin constituting the epoxy resin layers 34 within the protective film 33 has been made 5 GPa or less.

The epoxy resin layers 34 of the protective film 33 are made to be a multilayered protective film while laminating a plurality of moisture barrier layers 35 into a multilayered configuration. As a result, the moisture barrier layers 35 prevent defects such as pinhole of the epoxy resin layers 34, and can further minimize moisture permeability of the protective film 33. Consequently, the moisture permeability at the interface between the protective film 33 and the bias electrode layer 32 becomes not large, and thus it is possible to prevent permeation of the moisture from the protective film 33 into the bias electrode layer 32, and it is possible to suppress the defects after heating process due to high thermal resistance of the epoxy resin layer 34.

Further, it is possible to prevent cracks at the protective film 33 from occurring because the protective film 33 is protected by forming a multilayered configuration. Therefore, defects such as the pinhole is fewer than the conventional protective film 33 to suppress the moisture permeability low, whereby it is possible to realize the protective film 33 with small deterioration caused by influence of heating process.

Since the protective film 33 excellent in moisture barrier property can be uniformly formed with high reliability, micro-discharge is hard to occur in the photoelectric conversion unit 4, and therefore, the protective film 33 is made to be hardly deteriorated. For this reason, since it is possible to prevent deterioration of resolution and luminous efficiency in the photoelectric conversion unit 4, deterioration of the sensitivity characteristics and the resolution characteristics in the photoelectric conversion unit 4 can be suppressed over a long period of time. This makes it is possible to provide the X-ray detector 1 with high sensitivity characteristics and resolution characteristics over a long period of time.

Moreover, it becomes possible to cope with a large size glass substrate 3 by reducing the elasticity modulus of the epoxy resin layer 34 coming into contact with the photoelectric conversion unit 4 as much as possible. Since it is possible to inhibit the concentration of stress by the epoxy resin layer 34 coming into contact with the photoelectric conversion unit 4, stable adhesive strength over a long period of time can be maintained.

Meanwhile, in the above-described first embodiment, the protective film 33 is formed on the photoelectric conversion unit 4 of the X-ray detector 1 of the direct method. However, as the second embodiment shown in FIG. 3, the protective film 33 may be also formed on the photoelectric conversion unit 4 of the X-ray detector 1 of the indirect method. In this case, the photoelectric conversion unit 4 of the X-ray detector 1 has photodiodes 41 serving as substantially L-shaped tabular photoelectric conversion elements for converting an incident visible light into a signal charge as an electric signal. The photodiodes 41 are provided on the flattening layer 25 and the through holes 26 of the respective pixels 5.

Then, each photodiode 41 is formed pixel 5 as a pn diode structure or pin diode structure of the amorphous silicon (a-Si). Further, the photodiode 41 is provided in the pixel unit, that is, at a center part of each pixel 5 on the surface of the glass substrate 3. Furthermore, the drain electrode 13 of the thin film transistor 7 is electrically connected to the photodiode 41.

Here, each current collecting electrode 42 being the first electrode as being the lower electrode is laminated to be formed between the photodiode 41 and the flattening layer 25 including the through hole 26. The current collecting electrode 42 is positioned below the photodiode 41. More specifically, the current collecting electrode 42 is electrically connected to the drain electrode 13 of the thin film transistor 7 and the upper electrode 24 of the accumulating capacitor 8, respectively, via the through hole 26.

Further, the photodiode 41 is laminated on the current collecting electrode 42, the bias electrode layer 32 which is a second electrode as an upper electrode is laminated to be formed on the photodiode 41. The bias electrode layer 32 is formed in such a manner that an indium-tin oxide (ITO) transparent conductive film is formed by a sputtering method. Accordingly, a bias voltage is applied between the current collecting electrode 42 and the bias electrode layer 32 to form the bias electric field.

Further, a scintillator layer 43 of the columnar crystal as an X-ray conversion film for converting an incident X-ray into a visible light is laminated on the bias electrode layer 32. The scintillator layer 43, which has columnar structures 43a, is provided on the photodiodes 41. Further, the scintillator layer 43 covers periphery of the photodiodes 41 over the whole area in the circumferential direction. In other words, the scintillator layer 43 is provided in such a manner as to surround the periphery of the photodiode 41. Furthermore, the scintillator layer 43 is provided in such a manner as to overlap each other at the area which is regions in which the photodiodes 41 are formed. Therefore, the scintillator layer 43 is optically coupled to the photoelectric conversion substrate 2.

Further, a gap of the columnar structure 43a of the scintillator layer 43 is constituted to be filled with vacuum, inert gas or air. That is, the scintillator layer 43 is the columnar crystal constituted in such a manner that, using such a method as a deposition method, an electro beam (EB) method, or a sputtering method, phosphors (not shown) such as sodium iodide (NaI) or cesium iodide (CsI) are accumulated on the individual columnar structure 43a to form a film. Therefore, the scintillator layer 43 has high resolution because diffusion of the light generated by the columnar crystal of the scintillator layer 43 is small.

In addition, the protective film 33 is formed to be laminated on the scintillator layer 43. The protective film 33 covers the upper side of the scintillator layer 43 opposite to the side facing to the photodiodes 41. Here, the protective film 33 is preferred to be excellent in shielding property and have low moisture permeability so as to suppress deliquescence of CsI or NaI of the columnar crystal caused by influence of the moisture having intruded inside the scintillator layer 43.

Further, a reflection layer 44 is formed to be laminated on the protective layer 33. The reflection layer 44 is provided at the upper side of the protective film 33 opposite to the side facing to the scintillator layer 43. Consequently, the reflection layer 44 is formed on the protective film 33 so as to overlap each other on an area of the scintillator layer 43. Here, the reflection layer 44 is composed of a metallic material having higher reflectivity such as gold (Au), silver (Ag) or aluminum (Al), or metal oxide which is a white pigment with high reflectance of titanium dioxide (TiO₂) or gadolinium sulfated compounds (GOS).

When the reflection layer 44 is metallic material, the reflection layer 44 is formed on the protective film 33 by such a method as a silver salt method, a vacuum deposition method, or a sputtering method. Further, when the reflection layer 44 is metal oxide, a metal oxide is mixed with resin as a binder to prepare a coating liquid, and the coating liquid is coated on the protective film 33 by a solution cast method, a spray printing method, an ink jet method, a thermo compression bonding method or an electrostatic coating method, whereby the reflecting layer 44 is formed. Furthermore, a rectangular tabular supporting body 45 is mounted on the reflection layer 44.

Next, there will be described a function of the radiation detector of the above second embodiment.

First, an X-ray L successively passes through the supporting body 45, the reflection layer 44 and the protective film 33, and is made incident into the scintillator layer 43. Thereafter, the incident X-ray L is converted into a visible light at the scintillator layer 43.

Then, the visible light converted at the scintillator layer 43 is converted into a signal charge being an electric signal at each photodiode 41. At this time, each of the signal charge is accumulated in the accumulating capacitor 8 due to the bias electric field formed between the bias electrode layer 32 and the current collecting electrode 42 via the drain electrode 13.

As described above, in the above-described second embodiment, the protective film 33 having the epoxy resin layer 34 composed of the epoxy resin with the flexural modulus at the normal temperature to be not more than the flexural modulus of the glass substrate 3 of the X-ray detector 1 is formed on the scintillator layer 43 of the X-ray detector 1, and the epoxy resin layer 34 of the protective film 33 is laminated with a plurality of moisture barrier layers 35 into a multilayered configuration. Accordingly, it is possible to achieve the same operation and effect as the above-described first embodiment.

Further, it is possible to shield entrance of moisture and the epoxy resin entering gaps of the columnar structures 43a of the scintillator layer 43 by the inorganic filler contained in the epoxy resin layer 34 of the protective film 33 on the scintillator layer 43. Therefore, since the protective film 33 is not accumulated in the gaps of the columnar structures 43a of the scintillator layer 43, there is no case that the refractive index ratio of the columnar structure 43a and the gaps is nearer to 1. Thus, it is possible to prevent deterioration of the resolution and the reflection efficiency because the reflection efficiency within the columnar crystal of the columnar structure 43a becomes small. As a consequence, it is possible to suppress deterioration of the resolution characteristics caused by the protective film 33 being accumulated in the gaps of the columnar crystal of the columnar structure 43a of the scintillator layer 43. This makes it possible to maintain high luminous efficiency over a long time period, and also to suppress deterioration of the resolution.

Meanwhile, in the respective embodiments, there has been described about the X-ray detector 1 for detecting the X-ray L. However, even a radiation detector which detects various kinds of radiations such as, for example, γ-ray in addition to the X-ray L, can be utilized so as to cope with the conditions. Further, like an area sensor, the pixel 5 is formed such that the thin film transistor 7 and the pixel electrode 6 are formed on the glass substrate 3 of the photoelectric conversion unit 4, and such pixels 5 are formed in the two dimensional matrix shape along the vertical direction and the lateral direction, respectively. However, in the case of a line sensor, these pixels 5 may be provided on the glass substrate 3 of the photoelectric conversion unit 4 one dimensionally.

In addition, even the X-ray detector 1 which uses each thin film transistor 7 constituted by an amorphous semiconductor, a crystalline semiconductor, or a polycrystalline semiconductor may be used so as to cope with the conditions.

### EXAMPLES

First, there will be described Example 1 of the epoxy resin to be used for the protective film of the X-ray detector of the present invention.

51.7 wt. % of EXA-1000 (epoxy equivalent 343) (trade name: manufactured by Dainippon Ink and Chemicals, Incorporated), 17.5 wt. % of D-400 (an active hydrogen equivalent 116) (trade name: manufactured by Sun Techno Chemicals, Co., Ltd.), 0.15 wt. % of a surfactant, 30.12 wt. % of spherical silica, and 0.53 wt. % of a carbon based colorant were compounded and then mixed by a rotation and revolution type mixing apparatus to prepare a first epoxy resin.

Next, there will be described Example 2 of the epoxy resin to be used for the protective film of the X-ray detector of the present invention.

47.85 wt. % of EP-4000S (epoxy equivalent 260) (trade name: manufactured by Asahi Denka Kogyo K.K.), 21.35 wt. % of D-400 (an active hydrogen equivalent 116) (trade name: manufactured by Sun Techno Chemicals, Co., Ltd.), 0.15 wt. % of a surfactant, 30.12 wt. % of spherical silica, and 0.53 wt. % of a carbon based colorant were compounded and then mixed by a rotation and revolution type mixing apparatus to prepare a second epoxy resin.

Next, there will be described Example 3 of the protective film of the X-ray detector of the present invention.

The first epoxy resin prepared as an experiment in the above Example 1 was applied to a GX film (80 μm) (trade name: manufactured by Toppan Printing Co., Ltd.) with the thickness of 200 μm by using a bar coater, and was then subjected to heat treatment at 60° C. for 4 hours. Thereafter, the resultant was cut it into a predetermined size after the surface thereof became not sticky to thereby prepare a first multilayered protective film as a first multilayered moisture proof film to be the protective film 33.

Next, there will be described Example 4 of the protective film of the X-ray detector of the present invention.

The second epoxy resin prepared as an experiment in the above Example 2 was applied to a GX film (80 μm) (trade name: manufactured by Toppan Printing Co., Ltd.) with the thickness of 200 μm by using a bar coater, and was then subjected to heat treatment at 60° C. for 4 hours. Thereafter, the resultant was cut it into a predetermined size after the surface thereof became not sticky to thereby prepare a second multilayered protective film as a second multilayered moisture proof film to be the protective film 33.

Next, there will be described Example 5 the protective film of the X-ray detector of the present invention.

The first epoxy resin prepared as an experiment in the above Example 1 was applied to a tech barrier TCB-H film (75 μm) (trade name: manufactured by Toppan Printing Co., Ltd.) with the thickness of 200 μm by using a bar coater, and was then subjected to heat treatment at 60° C. for 4 hours. Thereafter, the resultant was cut it into a predetermined size after the surface thereof became not sticky to thereby prepare a third multilayered protective film as the third multilayered moisture proof film to be the protective film 33.

Next, respective physical property values of the first epoxy resin, the second epoxy resin, the first multilayered protective film, the second multilayered protective film and the third multilayered protective film prepared in the above-described Examples 1 to 5 were measured.

First, the moisture permeability was measured based on a JIS K-7129 B method (infrared sensor method) and a measuring method indicated in ASTM F-1249. In the measuring method, a portion of the film where there is no flaw, voids, or breakage was selected as a measuring sample, the moisture absorbing amount was measured from weight change at the atmosphere with 40° C. humidity 90% by means of a water vapor permeability measuring device (a serial number: PERMATRAN (R) W 3/61) made by MOCON company (USA), so that the moisture permeability was calculated.

Next, flexural modulus and breakdown voltage were measured based on JIS K-6911 (1995 edition).

Here, the flexural modulus based on JIS K-6911, which is a load within the elastic limit, is degree of deformation resistance of each test piece with respect to a bending stress in the linear part of a deflection curve. That is, the flexural modulus is represented with a bending stress per unit deformation. Therefore, each of the first epoxy resin, the second epoxy resin, the first multilayered protective film, the second multilayered protective film and the third multilayered protective film prepared in the above-described Examples 1 to 5 was taken to as the test piece, and a double end support beam was formed by supporting both ends of these test pieces. With this state, flexural strength was measured from the maximum bending stress when a concentrated load was added from above to center part of each test piece, and then, the flexural modulus was calculated from the flexural strength.

Further, the breakdown voltage based on JIS K-6911 is a withstand voltage. A specified voltage was defined as (specified voltage gradient×thickness of test piece), and whether the test piece was not broken down and was resistant to the condition where the prescribed voltage was applied during one minute was measured and calculated.

The moisture permeability, flexural modulus and dielectric breakdown strength of each of the first epoxy resin, the second epoxy resin, the first multilayered protective film, the second multilayered protective film and the third multilayered protective film are shown in Table 1.

TABLE 1

| | | | Dielectric |
|---|---|---|---|
| | Moisture | Flexural | breakdown |
| | permeability | modulus | strength |
| | [g/m² · day] | [Gpa] | [kV/mm] |
| First epoxy resin | 30 | 0.27 | 79 |
| Second epoxy resin | 40 | 0.4 | 75 |
| First multilayered | 0.01 | — | 89 |
| protective film | | | |
| Second multilayered | 0.02 | — | 94 |
| protective film | | | |
| Third multilayered | 0.2 | — | 77 |
| protective film | | | |

In the above-described embodiments, the protective film 33 is formed by the following methods. As the above-described first embodiment, the epoxy resin is applied to the moisture barrier layer 35 and primarily hardened (B stage), and then, the primarily hardened epoxy resin is cut into a predetermined size to be subjected to pressure bonding at a predetermined area, so that the protective film 33 is formed. In addition, a method is allowable in which the liquid epoxy resin filled in the syringe is applied to a predetermined area by an application robot, and a moisture proof film is subjected to pressure bonding after heat treatment in order to stabilize the shape of the application area. At this time, in order to suppress occurrence of voids at an interface between the epoxy resin layer 34 and the moisture barrier layer 35, it is also possible to use a method in which the protective film 33 is subjected to pressure bonding in the vacuum atmosphere.

From the matters described above, the present invention has the following advantage. That is, since the protective layer on the upper electrode has the flexural modulus which is not more than the flexural modulus of the electrode substrate, it is possible to suppress occurrence of crack at the protective layer. In addition, the moisture permeability at the interface of the protective layer becomes not large, and deterioration of the resolution and the luminous efficiency can be prevented. As a consequence, it is possible to provide a radiation detector having high sensitivity characteristics and high resolution characteristics with a long time stability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radiation detector comprising:
an electrode substrate;
pixel electrodes provided on the electrode substrate, and detecting electric signals;
a radiation conversion layer provided on the pixel electrodes, and converting incident radiations into electric signals;
upper electrodes provided at a position on the radiation conversion layer opposite to the pixel electrodes; and
a protective layer provided on the upper electrodes, the protective layer having a flexural modulus not more than a flexural modulus of the electrode substrate.

2. A radiation detector comprising:
an electrode substrate;
photoelectric conversion elements provided on the electrode substrate, and converting visible light into electric signals;
a scintillator layer provided on the photoelectric conversion elements, and converting incident radiations into the visible light; and
a protective layer provided on the scintillator layer, and having a flexural modulus not more than a flexural modulus of the electrode substrate.

3. The radiation detector according to claim 1, wherein the protective layer has a flexural modulus not more than 5 GPa at room temperature.

4. The radiation detector according to claim 2, wherein the protective layer has a flexural modulus not more than 5 GPa at room temperature.

5. The radiation detector according to claim 1, wherein the protective layer has an epoxy resin layer.

6. The radiation detector according to claim 2, wherein the protective layer has an epoxy resin layer.

7. The radiation detector according to claim 1, wherein the protective layer has an epoxy resin layer and a moisture-proof layer laminated with each other, and is a multilayered protective film with moisture permeability less than 50 g/m²·day.

8. The radiation detector according to claim 2, wherein the protective layer has an epoxy resin layer and a moisture-proof layer laminated with each other, and is a multilayered protective film with moisture permeability less than 50 g/m²·day.

9. The radiation detector according to claim 7, wherein the moisture-proof layer is laminated on the epoxy resin layer.

10. The radiation detector according to claim 8, wherein the moisture-proof layer is laminated on the epoxy resin layer.

11. The radiation detector according to claim 7, wherein the moisture-proof layer is a vapor deposition layer of either of silicon oxide (SiO₂) and aluminum oxide (Al₂O₃).

12. The radiation detector according to claim 8, wherein the moisture-proof layer is a vapor deposition layer of either of silicon oxide (SiO₂) and aluminum oxide (Al₂O₃).

13. The radiation detector according to claim 1, wherein the protective layer has an epoxy resin layer and at least two moisture-proof layers laminated with each other, and is a multilayered protective film with moisture permeability less than 50 g/m²·day.

14. The radiation detector according to claim 2, wherein the protective layer has an epoxy resin layer and at least two moisture-proof layers laminated with each other, and is a multilayered protective film with moisture permeability less than 50 g/m²·day.

15. The radiation detector according to claim 5, wherein the epoxy resin layer contains an inorganic filler.

16. The radiation detector according to claim 6, wherein the epoxy resin layer contains an inorganic filler.
